(19) United States
(12) Patent Application Publication
(10) Pub. No.: US 2014/0376747 A1
(43) Pub. Date: Dec. 25, 2014

(54) VOICE CONTROL OF LIGHTS AND MOTORIZED WINDOW COVERINGS

(71) Applicant: Qmotion Incorporated, Pensacola, FL (US)

(72) Inventors: Willis Jay Mullet, Gulf Breeze, FL (US); Matthew Warren Kirkland, Cantonment, FL (US)

(21) Appl. No.: 14/305,315

(22) Filed: Jun. 16, 2014

Related U.S. Application Data
(60) Provisional application No. 61/837,274, filed on Jun. 20, 2013.

(51) Int. Cl. G08C 23/00; H05B 37/00; H02P 23/00

(52) U.S. Cl. CPC G08C 23/00; H02P 23/0036; H05B 37/00
USPC 381/110

(57) ABSTRACT

A system for simultaneous wireless control of lights and motorized window coverings that include sheer interior shade material and blackout exterior shade material. The system includes a voice activation module which is wirelessly connected to a plurality of motorized window coverings using a first transceiver and a first wireless protocol and a plurality of lights using a second transceiver and a second wireless protocol. The voice activation module is preprogrammed to listen for a trigger phrase followed by any one of a number commands. Once the trigger phrase and a command are recognized, the wireless device transmits an over-the-air signal to the plurality of motorized window coverings and lights. The wireless device also includes an indicator that provides a visual or audible indication to the user that the trigger phrase, and/or a command has been recognized.

### CROSS REFERENCE TO RELATED APPLICATION

This application claims the benefit of U.S. Provisional Application No. 61/837,274 filed Jun. 20, 2013.

### FIELD OF THE INVENTION

This invention relates to a voice module. More specifically, and without limitation, this invention relates to a system and method for wireless voice activation of lights and motorized window coverings.

### BACKGROUND OF INVENTION

Sound or voice activation of electronic devices is old and well known in the art. An early example of sound activation of an electronic device includes what is well known as “The Clapper®”. The Clapper® is an electronic switch used to actuate electric appliances, such as a light or a TV, when two or three claps, separated by approximately half a second, are registered by a microphone in the device.

Later examples of using sound or voice activation of electronic. devices exist in cell phone technology. As one example. Samsung's Galaxy IIIS, includes an imbedded application that that listens for a trigger phrase, such as “Hello Galaxy”, and thereafter enters into a voice command mode where the user can instruct the phone to call or text one of the contacts, search the internet for information, or perform any one of a number of other operations. Similarly, Apple's iOS (iPhone Operating System) has an application named Siri that uses a natural language user interface to answer questions, make recommendations, and perform actions by delegating requests to a set of Web services.

Another later example includes the Ford SYNC® system which similarly allows a user to make hands-free phone calls, select and play music, enter a destination using onboard navigation, request emergency assistance, send a text message, receive a vehicle status report, among other options, all while driving.

Lights as well as motorized window coverings are also old and well known in the art, as is the electronic, control of lights and motorized, window coverings through the use of switches, remote controls and the like. Despite the prior art electronic devices used to control lights and motorized window coverings deficiencies and problems remain in the prior art.

In particular, the majority of control systems for lights and motorized window coverings require direct hard wiring to these components. While direct hard wiring systems are functional they are tremendously expensive and complex. In addition, hardwiring electric lights and motorized window coverings is prohibitively expensive to retrofit existing structures. As such, hard wired systems are almost exclusively limited to new construction or complete renovation projects, which eliminates most applications.

Recently, there has been an increased trend towards remote control of electronic devices. Common examples of these remote control devices are the conventional TV remote. One problem with remote controls is that they are often and easily lost, misplaced and/or stolen.

Never before has there been a voice activated remote control system for simultaneously controlling lights and motorized window coverings that allows a user to accurately and precisely and simultaneously actuate one or more motorized window coverings and lights using only their voice in an efficient, robust and easy to use manner.

Thus it is a primary object of the invention to provide a system and method fir wireless voice activation of lights and motorized window coverings that improves upon the state of the art.

Another object of the invention is to provide a system and method for wireless voice activation of lights and motorized window coverings that is easy to use.

Yet another object of the invention is to provide a system and method for wireless voice activation of lights and motorized window coverings that is intuitive.

Another object of the invention is to provide a system and method for wireless voice activation of lights and motorized window coverings that is simple.

Yet another object of the invention is to provide a system and method for wireless voice activation of lights and motorized window coverings that provide a plurality of ways to simultaneously activate lights and motorized window coverings.

Another object of the invention is to provide a system and method for wireless voice activation of lights and motorized window coverings that is inexpensive.

Yet another object of the invention is to provide a system and method for wireless voice activation of lights and motorized window coverings that allows for simultaneous activation of a plurality of lights and window coverings.

Another object of the invention is to provide a system and method for wireless voice activation of lights and motorized window coverings that allows for grouping of a plurality of motorized window coverings.

Yet another object of the invention is to provide a system and method for wireless voice of lights and motorized window coverings that allows for easy installation into existing structures.

Another object of the invention is to provide a system and method for wireless voice of lights and motorized window coverings that reduce the potential for a remote being lost.

These and other objects, features, or advantages of the present invention will become apparent from the specification, drawings and claims.

### SUMMARY OF THE INVENTION

A system for controlling at least one motorized window covering using wireless voice activation is presented. The system includes a voice activation module which is wirelessly connected to a plurality of motorized window coverings. The voice activation module is connected to a conventional power source, such as a wall plug, or batteries within the device, and the device is placed within activation proximity of the motorized window coverings. The voice activation module is preprogrammed to listen for a trigger phrase followed by any one of a number commands. Once the trigger phrase and a command are recognized, the wireless device transmits an over-the-air signal to the plurality a motorized window coverings. These preprogrammed commands include Open, Close, Position 1 (such as 25% closed), Position 2 (such as 50% closed), Position 3 (such as 75% closed). The wireless device also includes at least one push-button that is configured, when manually activated, to transmit an over-the-air signal to open and/or close the motorized window coverings. The wireless device also includes an indicator that provides a visual or audible indication to the user that the trigger phrase, and/or a command has been recognized. The system also allows for simultaneous wireless control of lights and motorized window coverings that include sheer interior shade material and blackout exterior shade material.

### BRIEF DESCRIPTION OF THE DRAWINGS

FIG. 1 is a perspective view of a system for wireless activation of motorized window coverings showing a motorized drapery in the open position, as well as an exploded perspective view of a motorized roller shade in a partially closed state, the view also showing a remote control and a voice activation module.

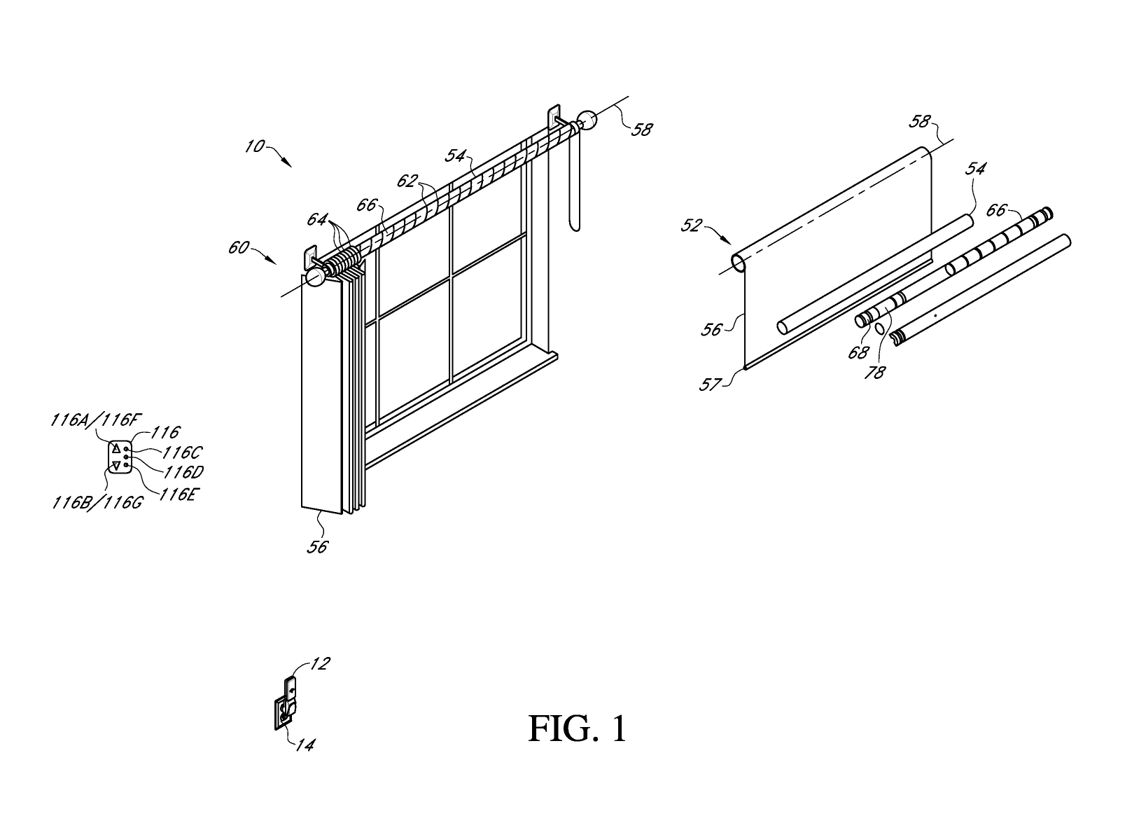

FIG. 2 is a perspective view of a system for wireless activation of motorized window coverings showing a motorized drapery in the closed position as well as the voice activation module.

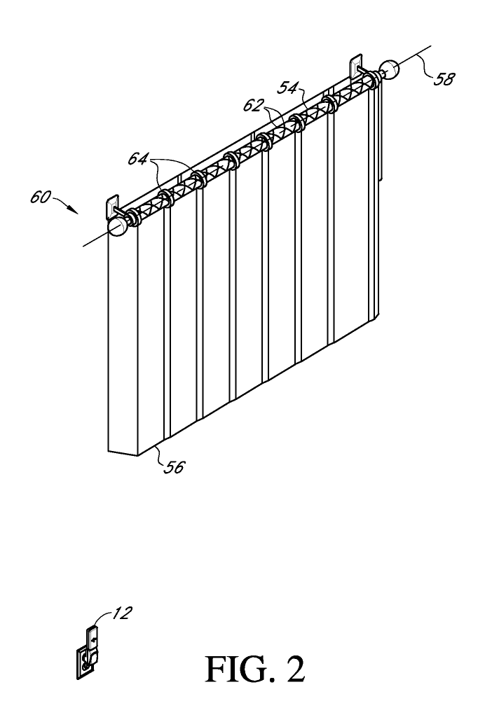

FIG. 3 is a front perspective view of a voice activation module of a system for the wireless control of motorized window coverings.

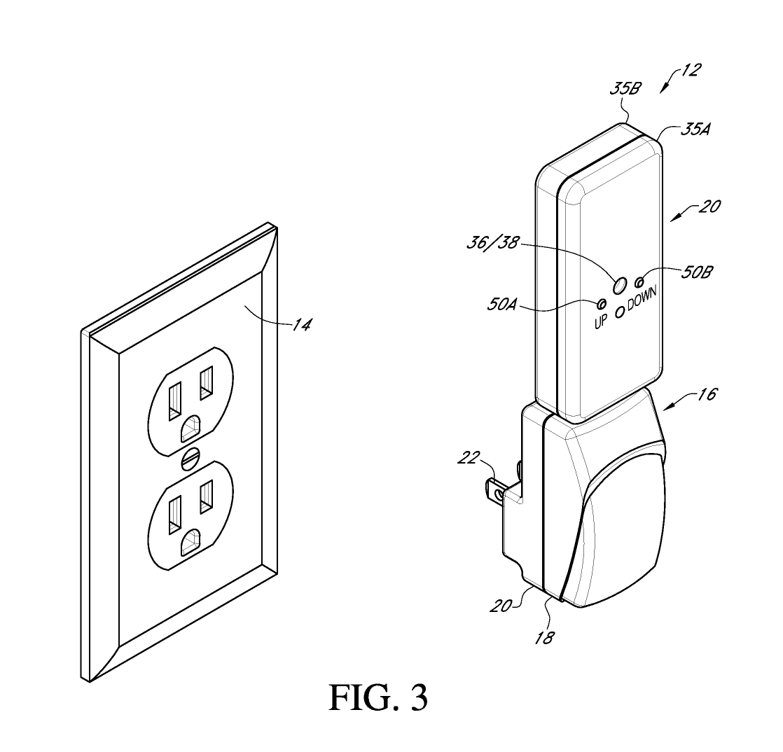

FIG. 4 is an exploded perspective view of the voice activation module of FIG. 4.

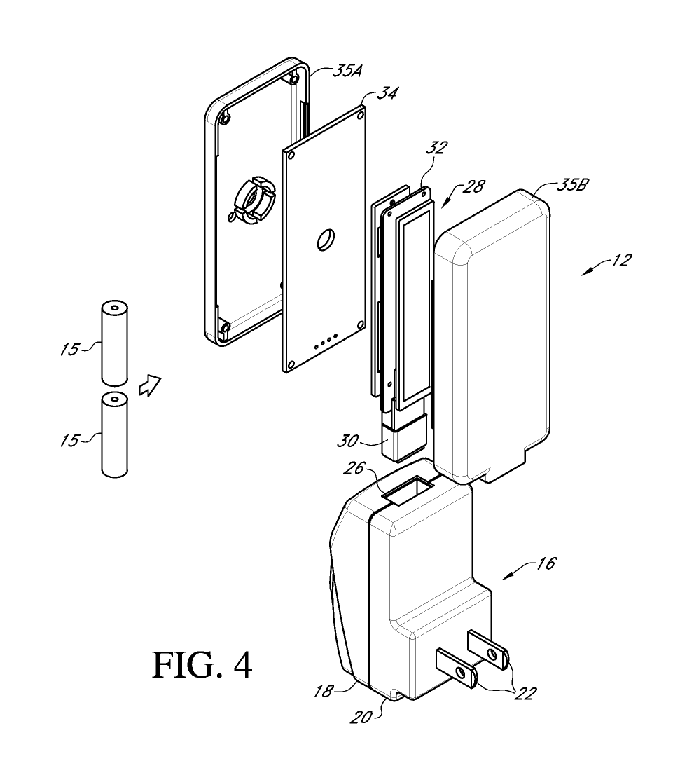

FIG. 5 is a plan view of a flow chart showing one method of operation of a system for the wireless activation of motorized window coverings.

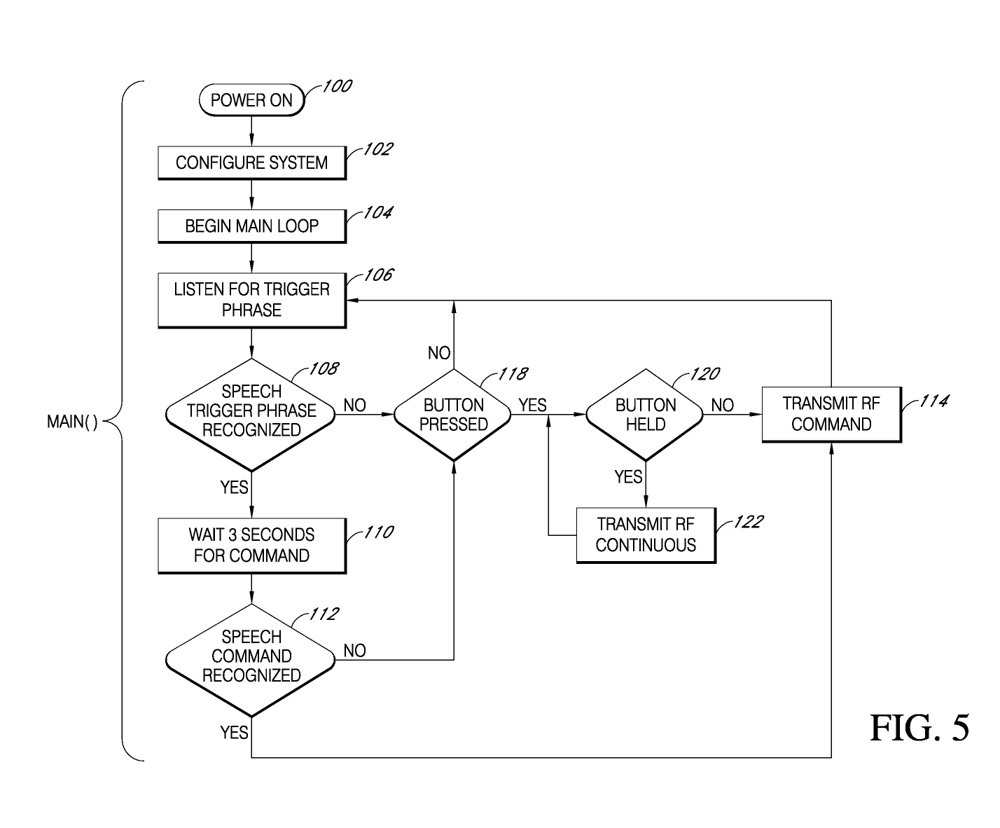

FIG. 6 is a plan view of the components of a voice activation module associated with the system.

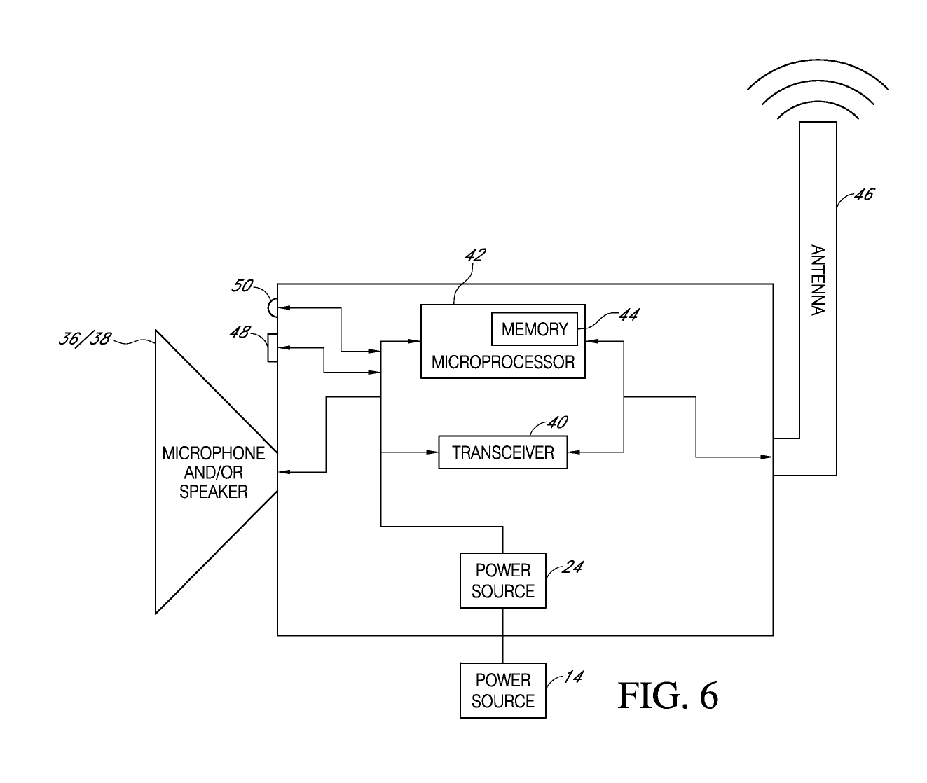

FIG. 7 is a plan view of a control module associated with the system.

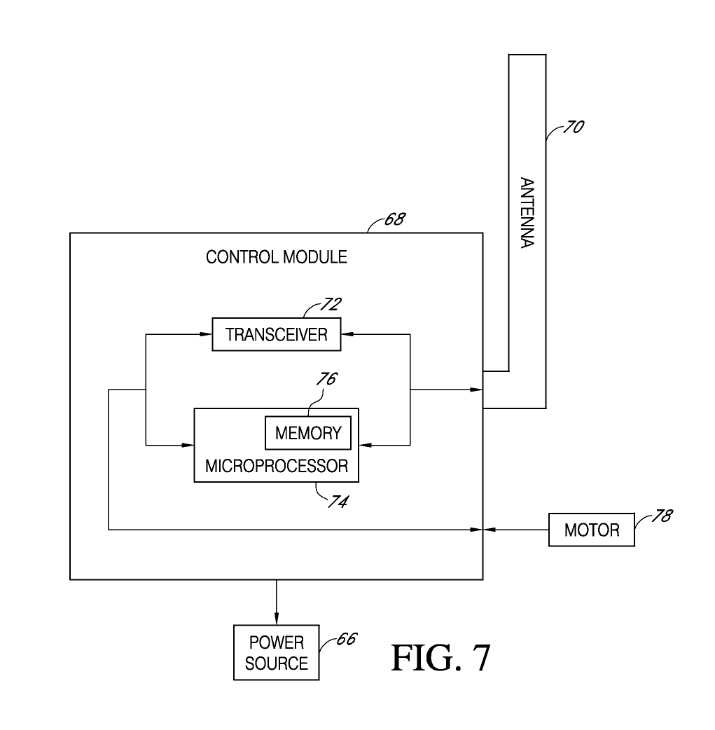

FIG. 8 is a perspective view of the system including a plurality of voice activation modules associated with a plurality of groups of motorized window coverings.

FIG. 9 is a plan view of the operating system of the voice activation module.

FIG. 10 is a plan view of a voice module having a first transceiver and a second transceiver, the first transceiver dedicated to the control of motorized window coverings, the second transceiver dedicated to the control of lights.

FIG. 11 is a perspective view of the system installed in a hotel room or bedroom, the system including a voice module wirelessly connected to a plurality of motorized window coverings, those that open vertically and those that open horizontally, each window covering having interior shade material and exterior shade material that is independently controllable through the voice module, and wirelessly controllable lights.

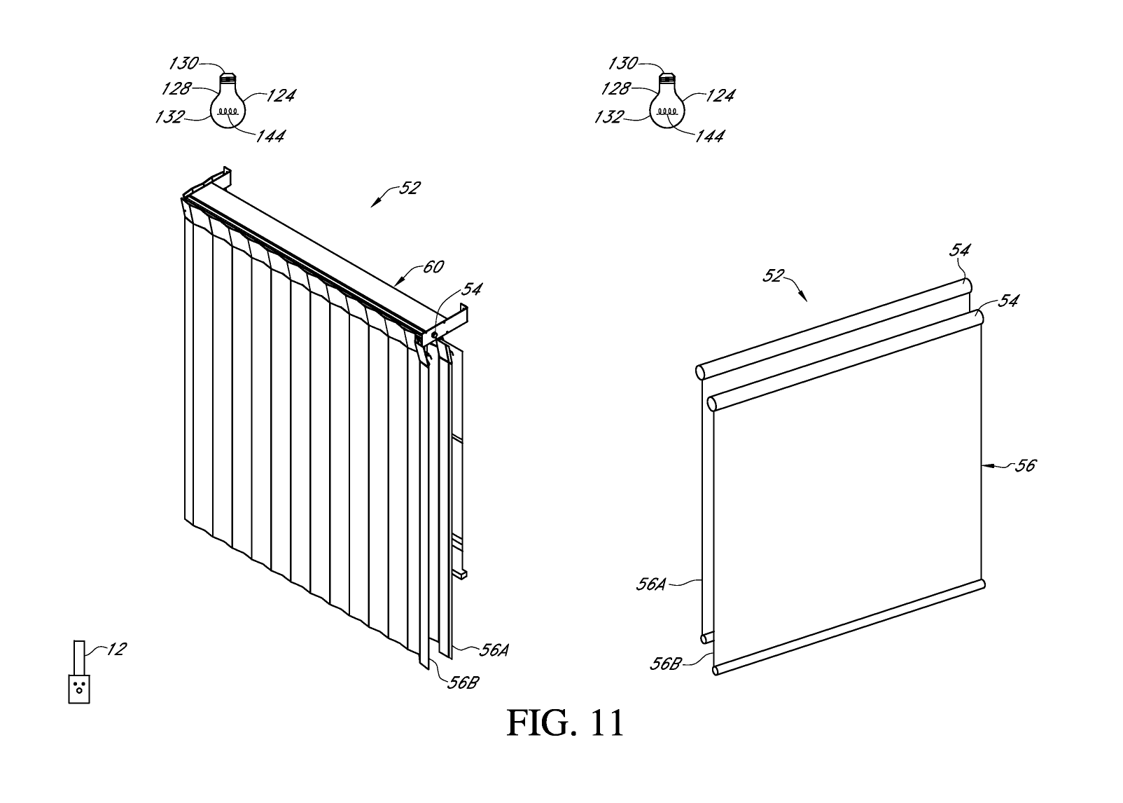

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention. The following detailed description is, therefore, not to be taken in a limiting sense, and the scope of the invention is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the invention.

As used herein, the invention is shown and described as being used in association with a plurality of window coverings. The term window coverings is generic and includes any form of an architectural coverings such as a shade, blind, drapery, roll shade, venetian shade, roman shade, or the like. Furthermore, while the invention is described as being used in association with electric lights and motorized window coverings, the invention is not so limited and can be used in association with any wirelessly controllable electronic device such as doors, windows, locks, dividers, barriers, lights, speakers, televisions, radios, cameras, vehicles, telephones, computers, TVs, appliances or any other motorized movable or non--movable electronic device or the like. Also, while the term window coverings is used consistently throughout, this term too is not meant to be limiting, and instead refers to any window covering such as a blind, shade, drapery or the like.

With reference to the Figures, a system 10 and method for wireless voice activation and control of motorized window coverings is presented. This system 10 presented herein is similar to the system presented in Applicant's related PCT Patent Application No. PCT/US14/132457 filed Apr. 1, 2014 and entitled “SYSTEM AND METHOD FOR WIRELESS VOICE ACTIVATION OF MOTORIZED WINDOW COVERINGS,” which is fully incorporated by reference herein, including any related applications.

Voice Activation Module: The system 10 includes a voice activation module 12 which is electronically connected to a power source 14. Power source 14 is any form electric power. In one arrangement, as is shown, power source 14 is a conventional AC wall outlet, into which voice activation module 12 is plugged. However any other form of electric power is hereby contemplated for use such as a battery system, a generator or the like. In an alternative arrangement, voice activation module 12 includes a power source 14 such as batteries 15 positioned within the voice activation module 12. In yet another arrangement, the voice activation module 12 is both battery powered, as well as capable of being plugged in to charge the batteries 15 and/or power the voice activation module 12.

Voice activation module 12 is of any form, shape or design. In one example, as is shown, voice activation module 12 includes a main housing 16 In the arrangement shown, main housing 16 has a clamshell design having a forward half 18 connected at a seam line to a rearward half 20. Main housing 16 also includes electrical connectors 22 which, in one arrangement, extend outwardly from the rearward half 10 for insertion into a standard wall plug. A power control unit 24 is positioned within main housing 16 and serves to convert, meter and distribute the power received from power source 14 into the proper form and amount so as to power the components of voice activation module 12.

Main housing 16 includes a connection slot 26. Connection slot 26 is any slot, socket or connection device used to connect two electrical components such as a USB port, an Ethernet connection port, or the like. In the arrangement shown, a USB port is depicted as one example.

In one arrangement, electronic component 28 is removeably and replaceably connected to connection slot 26. in an alternative arrangement, electronic component 28 is permanently affixed to main housing 16. Electronic component 28 includes plug 30 and frame 32. Plug 30 is any form of a connection plug or connection device that is used to connect two electrical components such as a USB plug, Ethernet plug, or the like. In the arrangement shown, as one example, plug 30 is in the form of a USB port and serves to removeably and replaceably connect electronic component 28 to connection slot 26.

Frame 32 is connected to plug 30. Frame 32 serves to connect and provide structural support and rigidity for the other components of electronic component 28 including PC board 34.

PC board 34 is any form of a printed circuit board (“PCB”) or similar device used to mechanically support and electrically connect the electronic components of the device, as is described herein, using conductive pathways, tracks or signal traces etched into Or connected to a non-conductive substrate. in one arrangement. PC board 34 and frame 32 are one and the same. In another arrangement, PC board 34 and frame 32 are independent units wherein the PC board 34 is connected to frame 32.

Cover 35 is positioned around the exterior of frame 32, electronic component 28 and PC board 34, with plug 30 extending. outwardly therefrom. In the arrangement shown, cover 35 has a clamshell design having a front half 35A and a rearward half 35B connected together at a seam line. The front half 35A has designated openings therein for a microphone 36 and/or speaker 38 as well as buttons and indicators as is described herein. In one arrangement, when cover 35 is assembled around frame 32, electronic component 28 and pc board 34, the plug 30 can be removed from as well as inserted into connection slot 26, In this way, electronic component 28 is a stand-alone unit and can be used to plug into any USB plug. In another arrangement, once assembled, plug 30 cannot be removed from connection slot 26 thereby making a single unitary device.

Voice activation module 12 includes a microphone 36, and a speaker 38. Microphone 36 is any device which receives an acoustic signal, or sound, and converts it into an electronic signal. Microphones are commonly referred to as acoustic-to-electric transducers or sensors. Speaker 38 is any device which produces sound or an audible response. Speakers are commonly referred to as an electromechanical or electroacoustic transducer that produces sound in response to an electrical audio signal input. In one arrangement, microphone 36 and speaker 38 are independent stand-alone units. In another arrangement, microphone 36 and speaker 38 are combined into a single unit. Without limitation, hereinafter, microphone 36 and speaker 38 shall be collectively referred to as microphone 36 possessing the function of both receiving an audible signal (microphone) and sending an audible signal (speaker). Microphone 36 receives and/or senses sound and voice commands, converts these sounds and voice commands to an electronic signal and transmits them to other components of voice activation module 12 as is described herein. Microphone 36 also transmits a sound acknowledgement or response when certain commands are received as is described herein.

In one arrangement, voice activation module 12 supports two way communication. In this arrangement, voice activation module 12 possess the ability to send electromagnetic or digital signals to a plurality of motorized window coverings and other electronic components, as well as possessing the ability to receive responsive signals from the plurality of motorized window coverings or other electronic components. In a two-way communication arrangement, voice activation module 12 includes a transceiver 40, as well as a microprocessor 42 and memory 44. In a one-way communication arrangement, voice activation module 12 only requires a transmitter which transmits signals to other components of system 10 and not a transceiver which transmits as well as receives signals. The following description is directed towards two-way communication, with the understanding that one-way communication is hereby contemplated and supported by this disclosure by eliminating the two-way features (that is replacing the herein described transceivers with receivers or transmitters).

Transceiver 40 is any device which transmits and receives an electronic signal. In one arrangement, the sending, and receiving functions of transceiver 40 are performed on common circuitry, whereas in an alternative arrangement, the sending and receiving circuitry is separate. Microprocessor 42 is any programmable device that accepts electronic signals or data as input, processes it according to instructions stored in memory 44, and provides results as output. In one arrangement, transceiver 40 transmits and receives an electromagnetic wave or electromagnetic signal in or around the range of 433 MHz radio wave, also known as radio frequency waves (RF), and/or uses AM or FM signals. In another arrangement, any other electromagnetic signal or frequency is used.

In one arrangement, microphone 36 picks up audible signals from its environment and converts them to an electronic signal and transmits them to microprocessor 42. Microprocessor 42 processes these electronic signals according to instructions stored in memory 44. When microprocessor 42 receives a signal it recognizes as a command, it instructs transceiver 40 to transmit control signals via electromagnetic signals or electromagnetic waves to other components of system 10 through antenna 46.

Antenna 46 is any electronic device which converts electric power into electromagnetic signals or electromagnetic waves, which are commonly known as radio waves or RF (radio frequency) (hereinafter collectively referred to as “electromagnetic signals” without limitation). In one arrangement these electromagnetic signals are transmitted via AM or FM RF communication, any other range of RF is hereby contemplated. In one arrangement, antenna 46 transmits as well as receives electromagnet signals. In transmission, a radio transmitter (transceiver 40) supplies an oscillating radio frequency electric current to the antenna's terminals, and the antenna radiates the energy from the current as electromagnetic waves or electronic signals (radio waves). In reception, the antenna intercepts some of the power of an electromagnetic wave or electromagnetic signal in order to produce a tiny voltage at its terminals that is applied to a receiver/transceiver 40.

Voice activation module 12 also includes an indicator 48. Indicator 48 is any device which provides a visual indication such as a light, LED, visual display or mechanical device. Indicator 48 provides the user with a visual indication of the status of the voice activation module 12. As one example, if indicator 48 is a light, when the voice activation module 12 is active the light is illuminated whereas when the voice activation module 12 is inactive or asleep the light is not illuminated. As another example, if indicator 48 is a light capable of producing multiple colors, such that when a command is recognized the light is green, and when a command is not recognized the light is red. Alternatively, indicator 48 is an audible sound such as a first tone or a beep which sounds when a command is received and understood, and a second tone or a beep when something similar to a command is received but not understood. In this way, indicator 48 provides the user with an instantaneous real-time visual and/or audible indication of the status of voice activation module 12.

Voice activation module 12 also includes at least one activation button 50. In the arrangement shown, voice activation module 12 includes an up button 50A which when manually activated or pressed, causes voice activation module 12 to transmit a first command, such as an open command, and a down button 50B which when manually activated or pressed, causes voice activation module 12 to transmit a second command, such as a close command. While only an up button 50A and a down button SOB are shown and explicitly described, any other number of buttons is hereby contemplated for use in association with voice activation module 12.

Motorized Window Coverings: A plurality of motorized window coverings 52 are electronically connected to the system 10. Motorized window coverings 52 are formed of any suitable size, shape and design. While countless forms of window coverings exist, there are essentially two broad categories of window coverings 52 which include vertically opening and closing window coverings, and horizontally opening and closing window coverings.

Vertically Opening. & Closing Window Coverings: In one arrangement, as is shown, vertically opening and closing motorized window coverings 52 are hereby contemplated for use with the system 10. As one example, a roller shade is shown for use with the system, the roller shade includes a roll tube 54 with shade material 56 wrapped around the tube 54. Window coverings of this type are commonly known as “roller shades” such as those manufactured by (Notion Incorporated, which are the subject of a plurality of patents and patent applications which are fully incorporated herein by reference including any and all related continuation, continuation-in-part, divisional or other related applications including: U.S. Pat. No. 8,299,734 entitled “High Efficiency Roller Shade” filed on Feb. 23, 2010, issued on Oct. 30, 2012 with application Ser. No. 12/711,192; and U.S. Pat. No. 8,368,328 entitled “Method Of Operating A Motorized Roller Shade” filed on Feb. 23, 2010, issued on Feb. 5, 2013 with application Ser. No. 12/711,193, among other related applications. When activated, window covering 52 rotates upon axis point 58 thereby wrapping or unwrapping shade material 56 around tube 54 thereby opening or closing the window covering 52 based on the direction of rotation. One improved feature of the QMotion motorized window coverings 52 is that they provide the ability to be battery powered, wirelessly controlled, moved by a motor as well as allowing for manual movement by a user merely by pulling the bottom bar 57. This manual movement of the motorized window coverings 52 is accomplished by under powering the motor of the shade (as one example, supplying less than 12 volts to a 24 volt rated motor). This causes the batteries to last a long time, the motor to run quietly, and the motor to rotate slowly. This allows the motor 78 to rotate with the shade tube 54. This arrangement allows for a manually movable window covering 52, a motorized window covering 52, as well as a window covering which is movable by the user's voice.

Horizontally Opening & Closing Window Coverings: In another arrangement, as is shown, horizontally opening and closing motorized window coverings 52 include a drapery unit 60 with tube 54 or rod having a helical feature 62 positioned on the exterior surface of the tube 54. In one arrangement, helical feature 62 includes a plurality of grooves; in another arrangement, helical features 62 include a plurality of threads. A plurality of connecting members 64 are positioned around drapery rod 60 and matingly engage helical features 62. Shade material 56 is connected to and hangs down from connecting members 64. In this arrangement, as tube 54 rotates around axis point 58 connecting members engage helical feature 62 which are forced in one direction, open or closed, depending on the direction of rotation of tube 54.

Sheer & Blackout Shade Material: In one arrangement, whether the window coverings 52 are vertically or horizontally opening and closing, window coverings 52 may include both interior shade material 56A and exterior shade material 56B, or said another way, are dual-shade window coverings. That is, each window covering, includes two layers of shade material 56. In one arrangement, interior shade material 56A is made of a light or sheer or semi-transparent material whereas exterior shade material 56B is made of a heavier or blackout material or other material that has less transparency than the interior shade material 56A. The interior shade material 56A and the exterior shade material 56B are independently controllable.

In one arrangement, window coverings 52 are wireless and battery powered, and include an internal power source 66, such as a plurality of batteries stacked within the tube 54 or a battery pack positioned within the tube 54. In another arrangement, window coverings 52 are connected to an external power source.

Control Module: Motorized window coverings 52 have a control module 68. Control module 68 receives electromagnetic signals from and communicates with voice activation module 12 which controls the operation of motorized window covering 52. Control module 68 is formed of any suitable arrangement and includes any and all necessary components to function properly. In one arrangement, control module 68 includes an antenna 70, which is similar or identical to antenna 46; a transceiver 72, which is similar if not identical to transceiver 40 (and in one-way communication may only he a receiver); a microprocessor 74 and memory 76, which are similar if not identical to microprocessor 42 and memory 44. Control module 68 is also electronically connected to power source 66 which supplies power to the needed components of motorized window covering 52 (which in one arrangement is a plurality of batteries 66). At least one motor 78 is also connected to and controlled by control module 68 which converts electrical energy to mechanical energy thereby actuating the opening or closing or other function of the motorized window covering 52.

Assembly: One or a plurality of motorized window coverings 52 are assembled and installed having a control module 68 having an antenna 70, transceiver 72, microprocessor 74, memory 76 and motor 78 which are connected to power source 68. A voice activation module 12 is inserted into a standard wall plug-in within effective over-the-air communication distance to motorized window coverings 52 (or alternatively powered by batteries within the device). Voice activation module 12 is wirelessly connected to the motorized window coverings 52 via over-the-air two-way communication through antennas 46/70 and transceivers 40/72.

Commands And Control: Voice activation module 12 is preprogrammed to recognize a trigger phrase 80 and plurality of voice commands 82 which are stored in a list within memory 76. In one arrangement, microprocessor 42 of voice activation module 12 is or includes the NLP-5x chip manufactured by Sensory Inc. of 4701 Patrick Henry Drive, Bldg. 7 Santa Clara, Calif. 95054. Alternatively, any other similar hardware and/or software that facilitate voice or sound recognition is used. The NLP-5x includes voice recognition algorithms 84 created by Sensory Inc, to assist with recognition of the trigger phrase 80 and voice commands 82. Algorithms 84 make recognition of trigger phrase 80 more robust to background noise than voice commands 82. When the voice activation module 12 receives sounds above a threshold level, the voice activation module 12 is brought out of a sleep state and/or into an awake state. When voice activation module 12 recognizes the trigger phrase 80 the voice activation module 12 is prepared to send command signals to motorized window coverings 52 based on the recognized voice command 82.

Voice activation module 12 is preprogrammed to recognize, trigger phrase 80. Trigger phrase 80 can be any word, sound, phrase, series of words, series of sounds, a sentence or the like. As one example, the trigger phrase 80 is “Hello QMotion”. Voice activation module 12 is also preprogrammed to recognize a plurality of voice commands 82. As examples these voice commands 82 include “Open” 86, “Close” 88. “Position One” 90, “Position Two” 92, “Position Three” 94. Any other number of positions can he learned. Any number of commands can be preprogrammed without limitation. In addition, while “Open” 86, “Close” 88, “Position One” 90. “Position Two” 92. “Position Three” 94 are used as examples for voice commands 82, these are only examples. Any other term or phrase can be used as voice commands 82 as can any language. As one example, “Middle” can be used in lieu of “Position Two” 92.

In the arrangement described, as one example, the “Open” 86 command activates motorized window covering 52 to a preprogrammed open position; the “Close” 88 command activates motorized window covering 52 to a preprogrammed closed position; the “Position One” 90 activates the motorized window covering 52 to a position of approximately 25% closed; “Position Two” 92 activates the motorized window covering 52 to a position of approximately 50% closed or half-closed; and “Position Three” 94 activates the motorized window covering 52 to a position of approximately 75% closed, While these may be the predetermined initial settings from the factory, any other position can be customizable set by the user to any other position between fully open and fully closed.

Groups: When using voice activation module 12 within effective over-the-air communication distance to a plurality of motorized window coverings 52, various motorized window coverings 52 can be organized into groups 96 using a group modifier 98. That is, once the system 10 is set-up, groups 96 are learned to the voice activation module 12 using a group modifier 98 to a voice command 82. As one example, group modifier 98 may include “Left Group” to indicate a group of motorized window coverings 52 positioned to the left side of a room, “Right Group” to indicate a group of motorized window coverings 52 positioned to the right side of a room, “Middle Group” to indicate a group of motorized window coverings 52 positioned at the middle of a room, as examples. When a group modifier 98 is recognized by voice activation module 12, transceiver 40 issues a limited control signal 99.

In Operation: One or a plurality of motorized window coverings 52 are assembled and connected, each motorized window covering 52 having a control module 68, an antenna 70, a transceiver 72, a microprocessor 74 and memory 76. At step 100, a voice activation module 12, having a microphone 36, a transceiver 40, a microprocessor 42, memory 44, an antenna 46 and an indicator 48 is connected to a conventional wall plug-in or is powered with batteries 15, positioned within effective over-the-air communication distance to motorized window coverings 52 and powered on.

At step 102 the plurality of motorized window Coverings 52 are learned to the voice activation module 12. At this step, the open position 86, closed position 88, position one 90, position two 92, position three 94 and any other position are learned and associated with their respective voice command 82. In addition, the plurality of motorized window coverings 52 are organized into groups 96 and associated with their respective group modifier 98, such as “Left Group”, “Right Group, and “Middle Group”. Position information associated with each voice command 82 stored in memory 44/76 of microprocessor 42/74 and associated with each voice command 82. Unique identification information for each motorized window covering 52 is also stored in memory 44/76 of microprocessor 42/74 and associated with each voice command 82. Any other commands are learned at step 102.

Once the voice activation module 12 is learned to the motorized window coverings 52, and all necessary information is stored in memory 44/76 of microprocessor 42/74, voice activation module 12 begins main loop at step 104 Once in the main loop, at step 104, standard operation begins. At step 106, voice activation module 12 constantly listens to sounds in the environment through microphone 36. As sounds are received by microphone 36, these sounds are converted to an electronic signal and transmitted to microprocessor 42 Microprocessor 42 filters these signals and pursuant to the instructions saved into memory 44 as well as the voice recognition algorithms 84, microprocessor 42 constantly attempts to determine whether trigger phrase SO has been received by microphone 36. This step requires filtering out background noise from trigger phrase 80 and recognizing trigger phrase 80. Algorithms 84 help with recognition of trigger phrase 80 from background noise and makes trigger phrase recognition robust to background noise contamination.

At this step, in one arrangement, when no sounds above a minimum threshold level are received by microphone 36, voice activation module 12 goes into a sleep state, or a power conserve state. When sounds are again received by microphone 36 above the minimum threshold level, voice activation module 12 enters into an awake state and again begins to determine whether an audible trigger phrase 80 was received. Depending on the state of the voice activation module 12, the indicator 48 may change state, as an example, when indicator 48 is a light, the light is oft in a sleep state, the light is on in an awake state; alternatively, the light is green when analyzing sounds, the light is red when sounds cannot be understood, etc.

At step 108, trigger phrase 80 is recognized by microprocessor 42. At step 110, once the trigger phrase 80 is recognized, voice activation module 12 listens for any voice command 82 for a predetermined amount of time. In one arrangement, voice activation module 12 listens for three seconds, however any other amount of time is hereby contemplated such as any portion of a second, one second, or any number of seconds such as two seconds, four seconds, five seconds, six seconds, seven seconds, eight seconds, nine seconds, ten seconds, or more or the like. As sounds are received by microphone 36, these sounds are converted to an electronic signal and transmitted to microprocessor 42. Microprocessor 42 filters these signals and pursuant to the instructions saved into memory 44 as well as the voice recognition algorithms 84, within the predetermined time period microprocessor 42 uses an algorithm 84, to recognize a voice command 82 was received. In one arrangement, the algorithm 84 used to recognize a voice command 82 is less robust or more sensitive than the algorithm 84 used to recognize a trigger phrase 80.

In one arrangement, during the predetermined period of time at step 110, indicator 48 is activated. That is, in the example wherein indicator 48 is a light, the light is illuminated at the moment trigger phrase 80 is recognized and remains illuminated during the predetermined amount of time for recognizing a voice command 82. Alternatively, if the indicator 48 is a speaker, a tone or beep is transmitted. This provides a user with an instantaneous and real-time visual double check and confirmation that voice activation module 12 recognized the trigger phrase 80 and is awaiting a voice command 82. Indicator 48 also provides the user with an instantaneous and real-time visual indication that the voice activation module 12 is no longer listening for a voice command 82 as too much time has elapsed between trigger phrase 80 and voice command 82. With this visual information, the user immediately knows that another trigger phrase 80 must be spoken in order to transmit a command signal.

Similarly, indicator 48 can be used to issue a visual signal upon reception of a trigger phrase 82, at entry into the waiting period for a voice command 82, at the expiration of the waiting period for a voice command 82, at the reception of a voice command 82, or at any other time. In one arrangement, indicator 48 is a light capable of producing multiple colors such that when a command is received and recognized the light is one color (such as green) and when a command is received and not recognized the light is another color (such as red). Similarly, microphone 36 (acting as a speaker) can be used to issue an audible sign al upon reception of a trigger phrase 82, at entry into the waiting period for a voice command 82, at the expiration of the waiting, period for a voice command 82, at the reception of as voice command 82, or at any other time. Or, alternatively, microphone 36 is used to transmit more than one audible signal, such as a happy, uplifting, or positive tone after each voice command 82 is received, and/or a sad, negative, or downbeat tone whenever the time period expires or a voice command 82 is not received within the specified period of time after recognizing a trigger phrase 80.

At step 112, a voice command 82 is recognized by microprocessor 42. Once voice command 82 is recognized, microprocessor 42 compares the voice command 82 with information and instructions saved within memory 44. At Step 114, voice activation module 12 transmits an electromagnetic signal, or control signal 99. More specifically, when microprocessor 42 recognizes a voice command 82, microprocessor 42 instructs transceiver 40 to transmit a corresponding control signal 99 to motorized window coverings 52 through antenna 46.

This control signal 99 travels over-the-air and is received by antenna 70 of motorized window covering 52. Antenna 70 transmits the electromagnetic signal to transceiver 72. Transceiver 72 interprets the electromagnetic signal and converts it to digital signal of 1s and 0s. This digital signal is then transmitted by transceiver 72 to microprocessor 74. Microprocessor 74 reads and interprets the digital signal based on the code and instructions saved within memory 76. If the signal is intended for that specific motorized window covering 52, microprocessor 74 instructs motor 78 to activate to the specified position which corresponds to the control signal 99.

In a two-way communication system, after activation or reception of a control signal 99, microprocessor 74 of motorized window covering 52 instructs transceiver 72 to transmit an acknowledgement of reception, or acknowledgement of activation, or acknowledgement of position, electromagnetic signal to voice activation module 12. Similar to that described previously herein with respect to motorized window covering 52, this electromagnetic signal is received by voice activation module 12 at antenna 46, transmitted to transceiver 40, converted into a digital signal of 1s and 0s and transmitted to microprocessor 42 wherein it is interpreted based on instructions stored in memory 44. Based on this information, voice activation module 12 will know the status of the motorized window coverings 52, know whether the command signal 99 was received, know the position of the motorized window coverings 52 or any other information requested. This information provides voice activation module 12 the ability to know whether the signal must be resent.

Remote: In one arrangement, a remote transmitter 116, having an up button 116A, a down button 116B, a first position button 116C, a second position button 116D, a third position button 116E, a jog up button 116F and a jog down button 116G is wirelessly connected to the plurality of window coverings 52. Open button 116A, when activated, opens motorized window coverings. Close button 116B, when activated, closes motorized window coverings. First position button 116C, second position button 116D and third position button 116E, when activated, move motorized window coverings 52 to a first predetermined position, a second predetermined position and a third predetermined position respectively. In one arrangement, these first, second and third predetermined positions are set at approximately 25% open, 50% open (or half open) and 75% open, respectively. While these may he the initial settings, first, second and third predetermined positions are customizable and can be set at any position by the user. Jog up button 116F and a jog down button 116G when activated, move motorized window coverings a predetermined incremental, amount between the open position and closed position. Any predetermined incremental amount is hereby contemplated such as is 1%, 2.5%, 5%, 7.5%, 10%, 12.5%, 15%, 17.5%, 20%, 22.5% or 25%, or the like. Or, alternatively, a specified distance is predetermined such as 1 inch, 2 inches, 3 inches, 4 inches, 5 inches 6 inches 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, 24 inches, or the like.

A similar process occurs when the up button 50A or down button 50B is pressed on the voice activation module 12. At step 118 a button 50A or 50B is pressed, at which point a control signal 99 is sent to motorized window coverings 52. At step 120 button 50A or 50B is continuously held, instead of being pushed and released. Upon recognition that button 50A or 50B is continuously held, at step 122, motorized window covering 52 enters into a learn mode.

Examples Of Voice Commands: As a first example, a user desiring to open all motorized window coverings within over-the-air effective communication distance to a voice activation module 12 may say “Hello QMotion”, the trigger phrase 80, followed by “Open” within the predetermined three seconds. In response, voice activation module 12 transmits an open 86 command signal 99 to all motorized window coverings 52 wirelessly connected to voice activation module 12.

As a second example, a plurality of motorized window coverings have learned position one, two and three to correspond to a 25%, 50% and 75% closed position, respectively. A user desiring to open all motorized window coverings to 50% may say “Hello QMotion”, the trigger phrase 80, followed by “Position Two” 92 within the predetermined three seconds. In response, voice activation module 12 transmits a command signal 99 to all motorized window coverings 52 wirelessly connected to voice activation module 12 to activate them to a middle position.

As a third example, a plurality of motorized window coverings in a single room have been organized into three groups 96, a left group, a middle group and a right group, and learned to these group modifiers 98 respectively. A user desiring to close only the left group of motorized window coverings may say “Hello QMotion”, the trigger phrase 80, followed by “Left Group”, the group modifier 98, followed by “Close” within the predetermined three seconds. In response, voice activation module 12 transmits a command signal 99 to all motorized window coverings 52 wirelessly connected to voice activation module 12. However, using the unique ID's associated with each motorized window covering 52, this control signal 99 is directed only to the specified window coverings 52 associated with the left group. These motorized window coverings activate to a closed position, while the remaining window coverings remain unchanged.

In one arrangement, a voice activation module 12 may recognize and he learned for the following voice commands 82:

To make the motorized window covering 52 to move to a position:
“Open Shade” or “Shade Open”
“Close Shade” or “Shade Close”
“Position One” or “25 Percent”
“Position Two” or “50 Percent” or “Middle” or “Half” or “Half Open” or “Half Closed”
“Position Three” or “75 Percent”
   These voice commands 82 are followed by activation of the motorized window covering 52.
“Jog Up” or “Jog Down”
   These voice commands 82 move the motorized window coverings 52 up or down a predetermined percentage of the distance between open and closed (such as 10%) or a predetermined distance (such as 5 inches).

To add or remove transmitters 116:
“Device Learn Mode”
“Learn Device”
“Remove Device”
   These voice commands $2 are followed by a single button press on the transmitter 116, a double button press on the transmitter 116, a single button press and hold for x-seconds on the transmitter 116, a double button press and hold for x-seconds on the transmitter 116, or any other method of associating the transmitter 116 with the particular motorized window coverings 52.

To change shade position presets to a customized position:
“Position Learn Mode”
“Learn Position”
   These commands 82 are followed by a position learning sequence on the specific motorized window coverings 52. In one arrangement, this sequence includes tugging the shade material 56, to select the appropriate shade, then. moving the shade material 56 to the appropriate position.

Turn audio feedback On/Off:
“Audio Off”
“Audio On”

These commands 82 turn on or off the audio confirmation signal when the trigger phrase 80 is recognized, the wait period terminates, a voice command 82 is recognized or any other process or event occurs.

Turn relay (repeater) mode On/Off
“Relay Mode Off”
“Relay Mode On”
   These commands 82 turn on or off the repeater function of voice activated module 12. In “Relay Mode On” mode, whenever voice activated module 12 receives an electromagnetic signal, such as a control signal 99, the voice activation module 12 repeats this signal. This provides the benefit of repeating the electromagnetic signal at a higher power so as to ensure that the control signal 99 reaches and is heard by the intended motorized window coverings 52.

To control all motorized window coverings 52 associated with the system 10 at the same time:
“All”
   As a modifier, “All” is used before or after a voice command 82 to instruct the voice activation module 12 to instruct all motorized window coverings 52 associated with the system 10 to perform the following voice command 82. As an example “Hello QMotion . . . All . . . Open” or “Hello QMotion . . . Close . . . All” this will cause voice activation module 12 to send a control signal 99 to all motorized window coverings 52 to open or close, respectively, using a single instruction. This voice command will open all motorized window coverings 52 in a home, building, office or the like. The reach of voice activation module 12 will be improved using multiple voice activation modules 12 when they are in “Relay Mode On” mode. In this way, when a user issues a voice command 82 in one room of a building having a voice activation module 12, that voice activation module 12 will recognize the voice command 99 and transmit it using an electromagnetic signal a thriller distance than the user's voice command will travel. Each additional voice activation module 12 that receives this electromagnetic signal will repeat it, and so on.
“Left”, “Right”, “Middle”, “Top”, “Bottom”, “First Group”, “Second Group”, “Third Group”, “Fourth Group”, etc., “Kitchen”, “Bedroom”, “Office”, “Family Room”, “Dining Room”, etc.
   These modifiers are used to direct commands to specific groups of motorized window coverings. These groups are learned by the voice activation module 12 by associating a unique ID associated with each motorized window covering with each group and transmitting control signals 99 directed specifically to those motorized window coverings These modifiers can be used before or after a voice command 99 to instruct the voice activation module 12 to instruct only those specified motorized window coverings 52 to perform the following voice command 82. As an example “Hello QMotion Kitchen . . . Open” or “Hello QMotion . . . Close . . . Middle” or “Hello QMotion Third Group . . . Position One” this will cause voice activation module 12 to send the specified control signal 99 to only the motorized window coverings 52 associated with the identified group.

To restart listening for a command:
“Hello QMotion”

Countless other voice commands 82 and modifiers 98 can be programmed and/or learned and used in any manner described herein.

Entering Learn Mode: The learn mode is entered into using any one of a number of ways.

### FIRST METHOD EXAMPLE

### Entering Learn Mode with Voice Commands

With the motorized window covering 52 in an open position and the voice activation module 12 plugged-in within effective over-the-air communication distance the user says the trigger phrase 80 “Hello QMotion”. If the trigger phrase 80 is recognized (the indicator light 48 illuminates and/or an audio confirmation is issued) the user says the voice command 82 “Device Learn Mode” within the specified wait period. The voice activation module 12 will acknowledge if the command was received and accepted or rejected through indicator 48, with green or red LEDs and positive or negative audible beeps. If recognized, the motorized window covering 52 will activate to approximately a 75% closed position of the total distance between an open position and a closed position, at which point the user tugs a specified window covering 52 to enter learn mode.

### SECOND METHOD EXAMPLE

### Entering Learn Mode with a Two Button Press

With the motorized window covering 52 in an open position and voice activation module 12 and/or transmitter 116 within effective over-the-air communication distance the user performs a two button press on the transmitter 116 or the voice activation module 12. This requires pressing the up button 50A or 116A and down button 50B or 116B and holding them for a predetermined amount of time, such as five, ten or fifteen seconds or the like. If recognized, the motorized window covering 52 will activate to approximately a 75% closed position of the total distance between an open position and a closed position, at which point the user must tug the specified window covering 52 to enter learn mode.

### THIRD METHOD EXAMPLE

### Entering Learn Mode with Buttons On Known Transmitter

With the motorized window covering 52 in an open position and voice activation module 12 and transmitter 116 within effective over-the-air communication distance to one another, hold the up button 50A on an already learned transmitter for a predetermined amount of time, such as fifteen seconds. The motorized window covering 52 will move down slightly then back up after approximately five seconds, however the user must continue to hold the up button 50A for the remaining five seconds of the ten second period. The motorized window covering 52 will then move to approximately a 75% closed position of the total distance between an open position and a closed position, at which point the user must tug the specified window covering 52 to enter learn mode.

### FOURTH METHOD EXAMPLE

### Entering Learn Mode by Powering Up

When the motorized window covering 52 is powered up form a total shut-down tall power off) when re-powered, the motorized window covering 52 will move to approximately a 75% closed position of the total distance between an open position and a closed position, at which point the user must tug the specified window covering 52 to enter learn mode.

Learning The Voice Module 12 To The Motorized Window Covering 52: Once the motorized window covering 52 is in learn mode, the voice activation module 12 is learned to the motorized window covering 52 in the following examples.

### FIRST METHOD EXAMPLE

### Using Voice Commands

The user states the trigger phrase 80 “Hello QMotion”. If the trigger phrase 80 is accepted, the user issues voice command 82 “Learn Device”. The motorized window covering will move to the open position and will acknowledge the voice activation module 12 as a learned transmitter. The voice activation module 12 can now be used to operate and control the motorized window covering 52.

### SECOND METHOD EXAMPLE

### Using Buttons On the Voice Activation Module

The user holds the open button 50A on the voice activation module 12 for a predetermined amount of time, such as approximately five seconds. The motorized window covering will move to the open position and will acknowledge the voice activation module 12 as a learned transmitter. The voice activation module 12 can now be used to operate and control the motorized window covering 52.

These methods can be used to learn a voice activation module to one or a plurality of motorized window coverings 52.

Repeater/Relay Mode: In more-complicated or expansive systems, such as large homes, office buildings or commercial properties, a single voice activation module 12 or a single transmitter 116 may not be able to reach all of the motorized window coverings therein due to the inherent and statutory limits associated with RF communication. In these applications, to help ensure that command signals 99 reach each and every motorized window covering 52 voice activation module 12 has a relay or repeater mode. In the relay or repeater mode, voice activation module 12 simultaneously listens for voice commands 82, spoken by a user, as well as control signals 99, transmitted by any other associated device, such as another voice activation module 12, a transmitter 116, a wireless gateway which is controlled by a computer, laptop, tablet, smart. phone or similar user controlled electronic device, or the like.

In this arrangement, transceiver 40 of voice activation module 12 receives an electromagnetic control signal 99 through antenna 46 and passes it to microprocessor 42. Microprocessor 42 recognizes that the electromagnetic signal is a control signal 99 from an associated device. The Microprocessor 42 instructs transceiver 40 to transmit the control signal 99 after a specified delay. In this way, voice activation module 12 acts as a relay or a repeater. This helps to activate distant motorized window coverings 52 by passing the control signal 99 from voice activation module 12 to voice activation module 12 and so on. In this arrangement, a distant voice activation module 12 may receive a control signal 99 that is of low strength or quality due to dispersion and repeat that signal with high strength and high quality. This strong and clear signal improves the chances that each intended motorized window covering 52 will receive the control signal 99 and respond appropriately. In one arrangement, where voice activation module 12 is connected to an endless power supply and motorized window coverings 52 are battery powered, voice activation module 12 is particularly well suited to continuously listen for control signals 99 repeat them high strength and quality because they are not limited by power. This same arrangement applies in a two-way communication system wherein the motorized window coverings 52 transmit responsive signals to voice activation module 12. The voice activation module 12 can also serve as a relay for learned remotes (transmitter 116) and not just other voice activation modules 12.

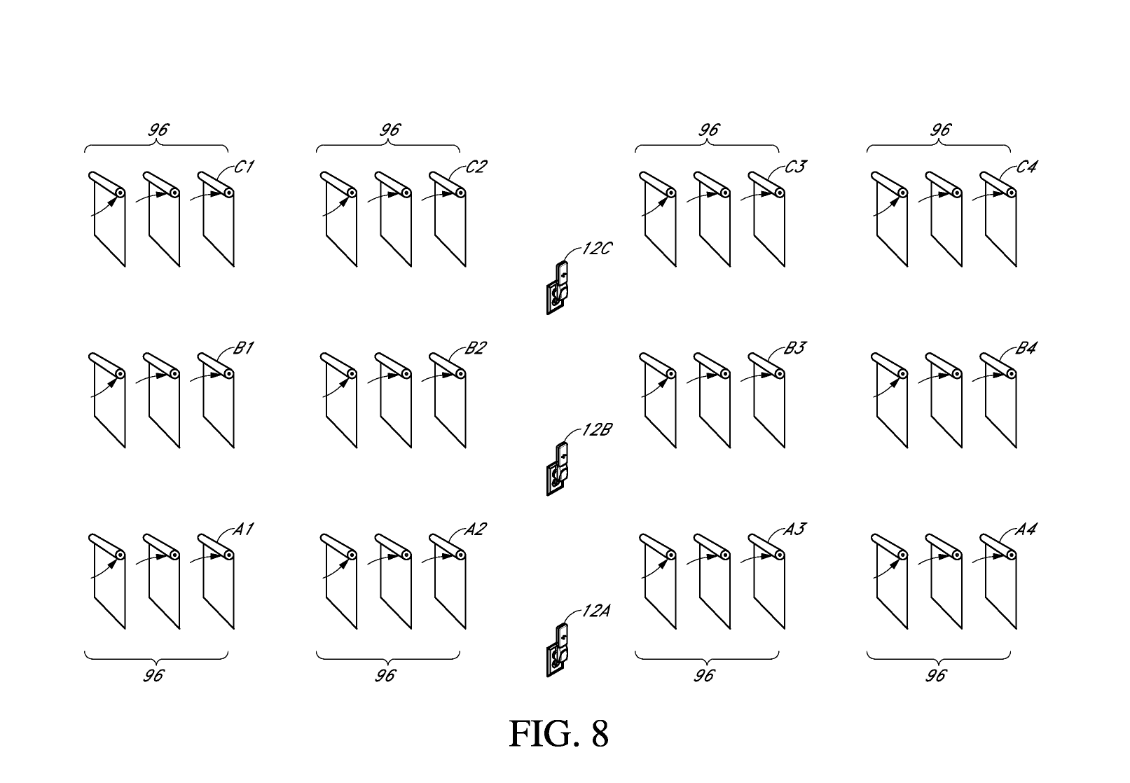

As one example of this arrangement, with reference to FIG. 8, a user in one room of a multi-room system issues a voice command 82 such as “Hello QMotion . . . Open . . . All” which is intended to open all motorized window coverings 52 associated with the system 10. The user's voice reaches the nearest voice activation module 12A, however it does not reach the other voice activation modules 12B, 12C . . . etc. Voice activation module 12A transmits a control signal 99 that reaches the nearest groups A1, A2, A3, A4 of motorized window coverings 52 with sufficient strength and clarity that this signal is easily received and interpreted by these motorized window coverings 52 such that they reliably activate to the correct position. As control signal 99 emanated by voice activation module 12A travels it loses strength and/or clarity due to dispersion and/or interference. Due to distance, control signal 99, may or may not reach the motorized window coverings 52 of the groups B1, B2, B3, B4, with sufficient strength and clarity to be easily received and interpreted by these motorized window coverings 52. If these motorized window coverings 52 receive the control signal 99 from voice activation module 12A, they will activate. If on the other hand, if these motorized window coverings 52 do not receive the control signal 99 from voice activation module 12A, they will not activate. However, because voice activation module 12B is plugged into a constant power source, voice activation module 12B constantly listens for control signals 99, and when in relay mode, relays these signals at higher power, strength and clarity. Therefore, when voice activation module 12B receives the control signal 99 from voice activation module 12A, voice activation module 12B repeats it, after a small delay. Due to the fact that motorized window coverings 52 of the groups B1, B2, B3, B4 are physically closer to voice activation module 12B, they receive a strong and clear signal and activate to the desired position. This process repeats itself through additional groups C1, C2, C3, C4, etc., and additional voice activation modules 12C, etc. Two-way communication between motorized window coverings 52 and voice activation modules 12, which occurs similarly to that described herein, only in the opposite direction, helps to assure that the specified motorized window coverings 52 activate when directed to do so. That is, two-way communication ensures that the window coverings 52 only activate once per signal.

Modifications: While the herein described examples include the voice activation module 12 being a separate unit from the motorized window coverings 52, in an alternative arrangement, the voice activation module 12 is included within and a part of the motorized window covering 52. This arrangement eliminates the need for additional componentry and simplifies the design.

In addition to using voice activation module 12 to control motorized window coverings 52, either through voice commands 82 or by pressing buttons 50, motorized window coverings 52 can be controlled using transmitter 116 as well as tugging. on shade material 56 of either a roller shade or drapery. Tugging on shade material 56 is sensed by a sensor of the control module 68. Motorized window covering 52 responds to recognition of a tug by actuating the motorized window covering to a predetermined position. As one example, when motorized window covering recognizes a single tug, motorized window covering 52 activates to an open position. As a second example, when motorized window covering 52 recognizes two tugs, motorized window coverings 52 activates to a closed position. As a third example, when motorized window covering 52 recognizes three tugs, motorized window covering 52 activates to a third position. This arrangement presents a never before found system that allows for voice activation as well as transmitter activation as well as activation by tugging shade material 56.

Hospitality Or Bedroom Arrangement: In an alternative arrangement, the system 10 is used in association with a hospitality room setting, such as a hotel room, a bedroom or any other room wherein it is desirable to activate motorized window coverings 52 simultaneously with lights 124 as well as any other electronic component 126 such as a TV, a barrier such as a garage door, locks, a thermostat, a furnace, an air conditioner, a fan, a radio, a security system, or any other electronic device.

Lights: In one arrangement, one or a plurality of lights 124 are wirelessly controllable in the same or similar fashion as motorized window coverings 52 as is described herein. Lights 124 are formed of any suitable size, shape and design. In one arrangement, lights 124 include a body 128 which contains all the components of the light 124. A plug 130 is positioned at one end of body 128. Plug 130 is formed of any suitable size, shape and design and serves as a means of connecting to an electric power source. In one arrangement, plug 130 is a conventional threaded light socket plug and serves to connect light 124 to a conventional external power source through a light socket. A lens 132 is positioned on the end of body 128 opposite plug 130. Lens 132 is any form of a transparent or semi-transparent member through which light can travel.

Light 124 also includes a control module 134 positioned within body 128 and electrically connected to plug 130. Control module 134 receives electromagnetic signals from and communicates with voice module 12 which controls the operation of light 124. Control module 134 is formed of any suitable size, arrangement and design and includes any and all necessary components to function properly. In one arrangement, control module 134 includes an antenna 136; a transceiver 138 for two-way communication (in one-way communication a receiver); a microprocessor 140 and memory 142.

Control module 134 is connected to and controls illumination device 144 or a plurality of illumination devices 144. Illumination device 144 is any light generating device such as an incandescent light bulb, a halogen light bulb, a light emitting diode (LED), a fluorescent light bulb, an xenon light bulb, or any other device or object that converts electric energy into light. Illumination device 144 is positioned adjacent the lens 132 of light 124 such that when illumination device 144 is illuminated the generated light radiates outwardly through lens 132. In one arrangement, illumination device 144 can dim and illuminate to various intensities, as well as light up various colors.

In one arrangement, light 124 is manufactured and sold by Philips Lighting B.V, Mathildelaan 1, 5611 BD, Eindhoven, The Netherlands (“Philips”) under the name “hue” personal wireless lighting. One advantage to using these lights 124 is that their outward appearance is practically identical to conventional lights, yet their capabilities are much greater while all that is required is that they are simply installed into a conventional light socket.

In one arrangement, light 124 operates using ZigBee communication utilizing electromagnetic signals or controls signals in the order of 2.4 GHz. ZigBee is a specification for a suite of high level communication protocols used to create personal area networks built from small, low-power digital radios. ZigBee is based on an IEEE 802.15.4 standard. Though low-powered, ZigBee devices often transmit data over longer distances by passing data through intermediate devices to reach more distant ones, creating a mesh network; i.e., a network with no centralized control or high-power transmitter/receiver able to reach all of the networked devices. The decentralized nature of such wireless ad-hoc networks make them suitable for applications where a central node can't be relied upon. In this way, each ZigBee device operates as a repeater for other ZigBee devices. In this arrangement, each light 124 serves as a repeater.

ZigBee is used in applications that require a low data rate, long battery life, and secure networking. ZigBee has a defined rate of 250 kbit/s, best suited for periodic or intermittent data or a single signal transmission from a sensor or input device. Applications include wireless light switches, electrical meters with in-home-displays, traffic management systems, and other consumer and industrial equipment that requires short-range wireless transfer of data at relatively low rates. The technology defined by the ZigBee specification is intended to be simpler and less expensive than other WPANs, such as Bluetooth or Wi-Fi.

While ZigBee is described herein, any other frequency and communication protocol is hereby contemplated for use such as Wi-Fi, Zwave, or the like.

Two Transceivers: One challenge to using a single voice module 12 to simultaneously control a plurality of electronic devices is that there is a broad array of communication protocols and electromagnetic frequencies that various manufacturers of electronic devices utilize to control their equipment. This poses a challenge because the single voice module 12 must be both multi-lingual (meaning it communicates using two or more communication protocols) as well as being able to communicate on two or more electromagnetic frequency ranges. As such, in the arrangement wherein a single voice module 12 is used to control motorized window coverings 52 which communicate on a first electromagnetic frequency range using a first communication protocol, and lights 124 which communicate on a second electromagnetic frequency range using a second communication protocol, two transceivers are needed, one dedicated for communication on each frequency utilizing each communication protocol.

As an example, voice module 12 is used to control motorized window coverings 52 that communicate in the range of 433 MHz and/or 908 MHz, such as those manufactured by motion Advanced Shade Systems having an address of 3400 Copter Road, Pensacola, Fla. 32514, and lights 124 which communicate using ZigBee communication protocol in the range of 2.4 GHz, such as those manufactured by Philips Lighting B.V, Mathildelaan 1, 5611. BD, Eindhoven, The Netherlands (“Philips”) under the name “hue” personal wireless lighting.

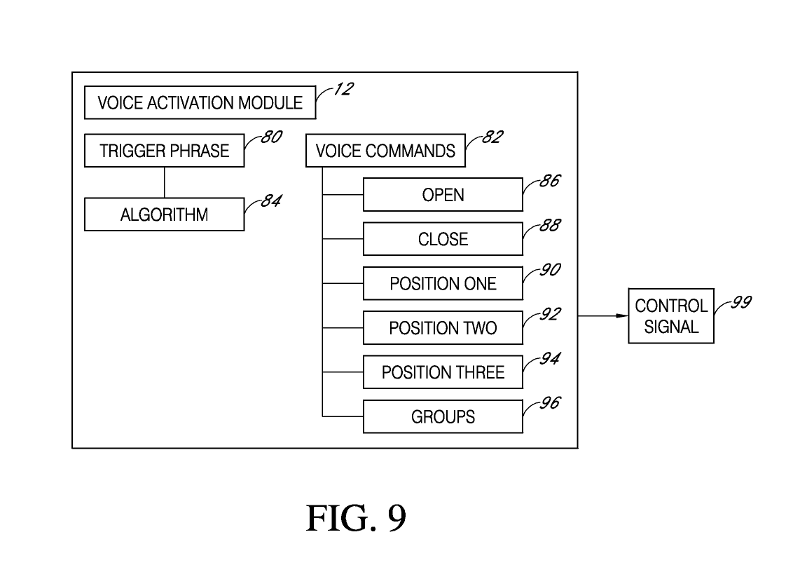

A voice module 12 capable of simultaneous communication and control of motorized window coverings 52 and lights 124 is shown in FIG. 9. This voice module 12 is similar to that described herein, with the transceiver 40 being replaced with a first transceiver 40A and a second transceiver 40B. The first transceiver 40A communicates on a first electromagnetic frequency using a first communication protocol, and the second transceiver 40B communicates on a second electromagnetic frequency using a second communication protocol. As one example, the first transceiver 40A communicates in the range of 433 MHz to 908 MHz to control motorized window coverings 52, and the second transceiver 40B communicates in the range of 2.4 Ghz to control lights 124.

While the addition of a second transceiver into the voice module 12 adds cost to the device, this cost is substantially less than the cost of having two voice modules 12, one dedicated to controlling one of motorized window coverings 12 and lights 124. In addition, by incorporating both transceivers 40A, 40B into a single device, the single device 12 operates seamlessly and reduces missed commands. This further streamlines the system by eliminating the need for two independent devices.

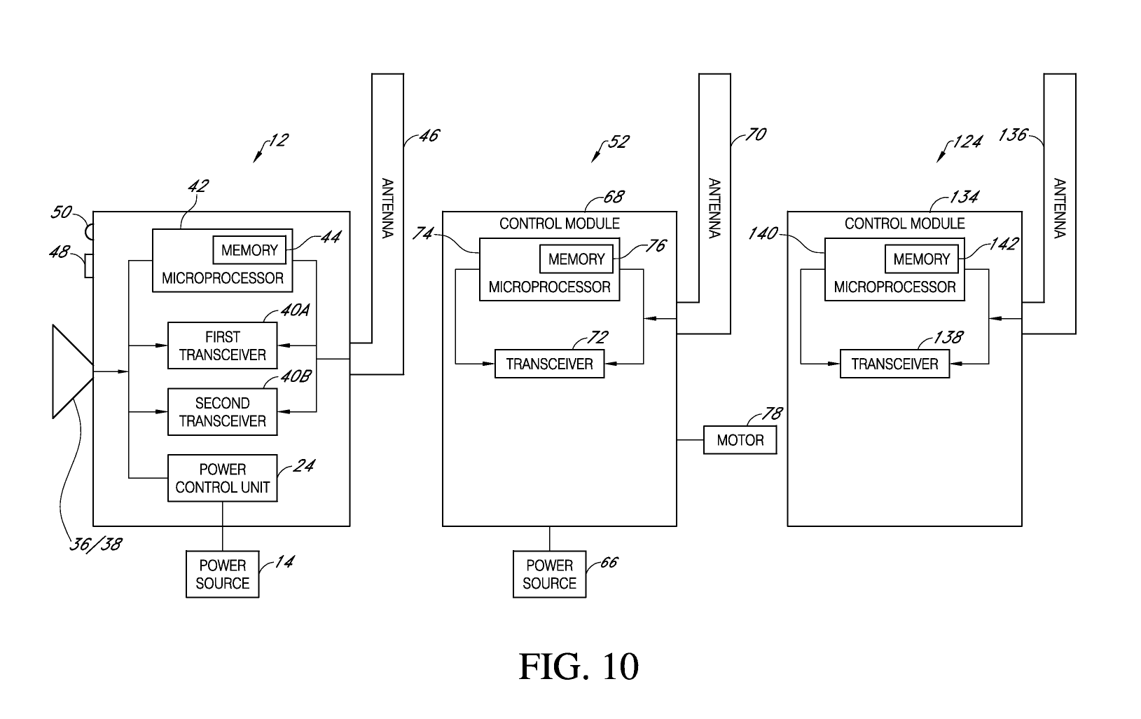

Room Set Up: As an example, with reference to FIG. 10, the system 10 is installed in a hotel room, a bedroom, or an other room or facility haying one or more windows and a plurality of light sockets. Motorized window coverings 52 include both single shade material window coverings and dual shade material window coverings 52 with independently controllable interior shade material 56A that is semi-transparent, and exterior shade material 56B that is mostly non-transparent are installed over each window. These include horizontally opening drapery products 60 as well as vertically opening shades 52 such as those offered by Qmotion Advanced Shading Systems. One or a plurality of lights 124 are installed in conventional light sockets within the room. A voice module 12 is also installed into the room. The voice module 12 having a first transceiver 40A therein which communicates on a dedicated electromagnetic frequency for motorized window coverings 52, and a second transceiver 40B therein which communicates on a dedicated electromagnetic frequency for lights 124.

The voice module 12 is learned to the motorized window coverings 52 and lights 124 in the manner described herein. Once learned, the voice module 12 can be used to independently control the motorized window coverings 12. Once learned, the voice module 12 can also be used to independently control the lights 124. In addition, the voice module 12 can be used to simultaneously control both motorized window coverings 52 and lights 124.

Dual Shade Window Covering Commands: The motorized window coverings 52 can be independently controlled using all the voice commands 82 described herein in the manner described herein. Additional commands are used to specifically control dual shades having interior shade material 56A and exterior shade material 56B.

In one arrangement, of interior shade material 56A and exterior shade material 56B are grouped into groups 98, or said another way, group modifiers 98 are used to specifically control the interior shade material 56A and/or the exterior shade material 56B. That is, in the manner described herein, when voice module 12 receives the group command 98 for either the interior shade material 56A or exterior shade material 56B all interior shades or exterior shades are controlled together. Examples of these group modifiers 98 include:
“Interior Shades”, “Sheer Shades” or the like—for control of the interior shade material 56A.
“Exterior Shades”, “Blackout Shades” or the like—for control of the exterior shade material 56B.

As one example, a user desiring to open all blackout shades, or exterior shade material 56B of motorized window coverings 52 within over-the-air effective communication distance to a voice module 12 may say “Hello QMotion”, the trigger phrase 80, followed by “Open” and “Blackout Shades” within the predetermined time period. In response, voice module 12 transmits a command signal 99 to all motorized window coverings 52 wirelessly connected to voice module 12 and directs them to open the exterior shade material 56B.

As another example, a user desiring to close all sheer shades or interior shade material 56B of motorized window coverings 52 within over-the-air effective communication distance to a voice module 12 may say “Hello QMotion”, the trigger phrase 80, followed by “Interior Shades” and “Close” within the predetermined time period. In response, voice module 12 transmits a command signal 99 to all motorized window coverings 52 wirelessly connected to voice module 12 and directs them to close the interior shade material 56A.

As another example, a plurality of motorized window coverings 52 having interior shade material 56A and exterior shade material 56B have learned positions one, two and three to correspond to a 25%, 50% and 75% closed position, respectively. A user desiring to open all exterior shade material 56B to an open position and all interior shade material 56A to a to 50% closed position may say “Hello QMotion”, the trigger phrase 80, followed by “Exterior Shade” and “Open” followed by “Interior Shade” and “50 Percent” within the predetermined three seconds. in response, voice module 12 transmits a command signal 99 to all motorized window coverings 52 wirelessly connected to voice module 12 to activate the exterior shade material 56B to an open position and the interior shade material 56A to a middle position.

In one arrangement, when a combination of motorized window coverings 52 are used, some with only one layer of shade material 56, and others with two layers of shade material 56A and 56B, the single layer of shade material 56 is treated the same as either the exterior shade material 56B, or the interior shade material 56A. As an example of this arrangement, when a simple “Open” command is transmitted by a voice module 12 learned to a plurality of motorized window coverings 52 including both single shade material 56 window coverings 52 and dual shade material 56A and 56B window coverings 52, the single shade material 56 window coverings 52 open as does the exterior shade material 56B of the dual shade window coverings 52. That is, when there is no modifier to a voice command 82 identifying whether the interior shade material 56A or exterior shade material 56B is to be activated, only one of the interior shade material 56A or exterior shade material 56B is activated.

In an alternative arrangement, when a combination of motorized window coverings 52 are used, some with only one layer of shade material 56, and others with two layers of shade material 56A and 56B, then both layers 56A and 56B are activated along with the single layer of shade material 56. As an example, when a simple “Open” or “Close” command is issued both interior shade material 56A and exterior shade material 56B are opened or closed along with the shade material 56 of the single layer window coverings 52.

Light Commands: Lights .124 can be controlled using the same manner and method described herein by issuing various voice commands 82.

In one arrangement, lights 124 is controlled using group modifiers 98 such as “Lights”. That is, when the group modifier 98 is issued, the voice module transmits control signals 99 to lights 124. Thereafter, light control commands are issued. Light control commands include:
“On” and “Off” —which turn on and turn off lights 124.
“Dim” or “Darker” or “Darken” —causes the lights dim the lights a predetermined amount (such as 5%), or a further command stating the percentage that the lights 124 are to he dimmed is also issued (such as “Dim 20%” causes the lights to dim by 20%).
“Brighten” or “Brighter” —causes the lights get brighter by a predetermined amount (such as 5%), or a further command stating the percentage that the lights 124 are to be dimmed is also issued (such as “Brighten 7%” causes the lights to brighten by 7%).
“Color” followed by a name of the desired color such as “White”, “Green”, “Blue”, “Yellow”, “Red”, “Purple”, “Pink”, “Magenta”, “Cyan”, “Orange”, “Violet”, “Indigo”, or any other named and programmed color—causes the lights 124 to transmit this color light.
“Percentage” preceded or followed by a number between 0 and 100—causes the lights to illuminate to that level between off and 100% on.

As one example, when the lights are off a user desiring to turn on lights 124 to 60% power and illuminate a green color says “Hello QMotion”, the trigger phrase 80, followed by “Lights” and “On” and “60%” and “Green”. In response, voice module 12 transmits a command signal 99 through second transceiver 408 to all lights 124 and directs them to power on to 60% power, at a color green.

As another example, when the lights are on and the user wants to dim the lights a small amount the user says “Hello QMotion”, the trigger phrase 80, followed, by “Dim” and “Lights”. As no specified amount of dimming was issued, the lights 124 will be dimmed a predetermined amount, such as 5%. Alternatively, if the user wants to dim the lights a specified amount, such as 30%, the user states says “Hello QMotion”, the trigger phrase 80, followed by “Dim” and “Lights” and “30 Percent”. This will reduce the power of the lights by 30%.

In one arrangement, the range of brightness of light 124 is broken down into predetermined positions wherein a. unique command signal is associated with each position. As one example, if 100 positions between fully off and fully on are preprogrammed, as the light is jogged brighter or dimmer the light moves 1% brighter or dimmer.

Simultaneous Control Of Window Coverings & Lights: It is well known that abruptly turning lights on or off and abruptly opening or closing window coverings is somewhat shocking and uncomfortable. As such, various commands are used to simultaneously control both the window coverings 52 as well as lights 124 to avoid abrupt changes in light. Examples of these simultaneous commands include:
“Good Morning” or “Good Day” or “Morning” or “Day” —causes the lights 124 to turn on and slowly or gradually get brighter over time. When window coverings 52 having a single shade material 56 are used, the window coverings also slowly open over time. When window coverings 52 having interior shade material 56A which is sheer, and exterior shade material 56B which is blackout, the exterior shade material slowly opens over time while leaving the interior shade material 56A closed. The time can be any amount of time, examples of which include 30 seconds, 5 minutes, 10 minutes, or the like.

“Good Night” or “Good Evening” or “Evening” or “Night” —causes the lights 124 to turn to slowly or gradually dim over time and eventually turn off. Window coverings also slowly close over time, whether they have a single shade material 56, or dual shade material 56A and 56B.

As example, when a user wakes up in a hotel room having system 10, the user says “Hello QMotion”, the trigger phrase 80, followed by “Good Morning” within the predetermined time period. In response, voice module 12 transmits a command signal 99 through first transceiver 40A to all motorized window coverings 52 wirelessly connected to voice module 12 and directs the single shade material window coverings 52 to open slowly, and directs the dual shade material window coverings 52 to open the exterior shade material 56B to open slowly while leaving the interior shade material 56A closed. Simultaneously, voice module 12 transmits a command signal 99 through the second transceiver 40B to all lights 124 wirelessly connected to the voice module 12 and directs them to turn on and slowly brighten.

As another example, when a user climbs in bed in their home having system 10, the user says “Hello QMotion”, the trigger phrase 80, followed by “Good Night” within the predetermined time period. In response, voice module 12 transmits a command signal 99 through first transceiver 40A to all motorized window coverings 52 wirelessly connected to voice module 12 and directs the either the single shade material window coverings 52 to close slowly, and directs the dual shade material window coverings 52 to close both the exterior shade material 56B and interior shade material 56A. Simultaneously, voice module 12 transmits a command signal 99 through the second transceiver 40B to all lights 124 wirelessly connected to the voice module 12 and directs them to slowly dim and eventually turn off.

In an alternative arrangement, the trigger phrase 80 is not used, and the “Good Morning” or “Good Night” commands alone are used to activate the system in this manner. In this arrangement, algorithms 84 is used to make recognition of these commands 82 more robust to background noise than other voice commands 82.

Alarm Clock: In one arrangement, voice module has an “Alarm Clock” command wherein the user can state any command described herein and delay the transmission of the associated control signals 99 by a specified amount of time.

As one example of using the alarm clock command, a user desiring to slowly open the window coverings 52 and slowly brighten the lights 124 at 6:15 AM in the morning states: “Hello QMotion” the trigger phrase 80, followed by “Alarm Clock” and “6:15 AM” and “Good Morning”. Voice module 12 will then transmit a “Good Morning” signal at the specified time.

TV: The system 10 described herein can also be modified to include and control any other number of electronic devices such as TVs and the like. In one arrangement, a third, fourth or more transceivers are added to the voice module to control each additional electronic device. In the TV example, the voice module 12 and the “Good Morning” and “Good Evening” commands can simultaneously be used to turn on and turn off the TV as well.

Color Temperature & Scenes: The system 10 can also be used to set scenes by adjusting the color temperature of the lights 124. Color temperature is a characteristic of visible light that has important applications in lighting, photography, videography, publishing, manufacturing, astrophysics, horticulture, and other fields. The color temperature of a light source is the temperature of an ideal black body radiator that radiates light of comparable hue to that of the light source. In practice, color temperature is only meaningful for light sources that do in fact correspond somewhat closely to the radiation of some black body, i.e. those on a line from reddish/orange via yellow and more or less white to blueish white; it does not make sense to speak of the color temperature of e.g. a green or a purple light. Color temperature is conventionally stated in the unit of absolute temperature, the kelvin, having the unit symbol K.

Color temperatures over 5,000K are called cool colors (blueish white), while lower color temperatures (2,700-3,000 K) are called warm colors (yellowish white through red). This relation, however, is a psychological one in contrast to the physical relation implied by Wien's displacement law, according to which the spectral peak is shifted towards shorter wavelengths (resulting in a more blueish white for higher temperatures.

The color temperature of the electromagnetic radiation emitted from an ideal black body is defined as its surface temperature in kelvins, or alternatively in mired (micro-reciprocal kelvins). This permits the definition of a standard by which light sources are compared.

To the extent that a hot surface emits thermal radiation but is not an ideal black body radiator, the color temperature of the light is not the actual temperature of the surface. An incandescent lamp's light is thermal radiation and the bulb approximates an ideal black body radiator, so its color temperature is essentially the temperature of the filament.

Many other light sources, such as fluorescent lamps, emit light primarily by processes other than thermal radiation. This means the emitted radiation does not follow the form of a black body spectrum. These sources are assigned what is known as a correlated color temperature (CCT). CCT is the color temperature of a black body radiator which to human color perception most closely matches the light from the lamp. Because such an approximation is not required for incandescent light, the CCT for an incandescent light is simply its unadjusted temperature, derived from the comparison to a black body radiator.

The Sun closely approximates a black body radiator. The effective temperature, defined by the total radiative power per square unit, is about 5,780 K. The color temperature of sunlight above the atmosphere is about 5,900 K.

As the Sun crosses the sky, it may appear to be red, orange, yellow or white depending on its position. The changing color of the sun over the course of the day is mainly a result of scattering of light, and is not due to changes in black body radiation. The blue color of the sky is caused by Rayleigh scattering of the sunlight from the atmosphere, which tends to scatter blue light more than red light.

Daylight has a spectrum similar to that of a black body with a correlated color temperature of 6,500 K (D65 viewing standard) or 5,500 K (daylight-balanced photographic film standard).

For colors based on black body theory, blue occurs at higher temperatures, while red occurs at lower, cooler, temperatures. This is the opposite of the cultural, associations attributed to colors, in which “rod” is “hot”, and “blue” is “cold”.

For lighting building interiors, it is often important to take into account the color temperature of illumination. For example, a warmer (i.e., lower color temperature) light is often used in public areas to promote relaxation, while a cooler (higher color temperature) light is used to enhance concentration in offices.

CCT dimming for LED technology is regarded as a difficult task, since binning, age and temperature drift effects of LEDs change the actual color value output. Here feedback loop systems are used for example with color sensors, to actively monitor and control the color output of multiple color mixing LEDs.

Hereinafter, the term “color” shall be used to describe the color temperature or the correlated color temperature. It is advertised that the Philips “hue” is capable of producing approximately 16 million distinct colors across the color temperature scale. The Philips “hue” is also capable of producing these colors at countless levels of brightness.

As such the user can use the voice module 12 to adjust both the color of light 124 as well as the brightness or level of illumination of the light 124. This capability is used to set various scenes.

As one example, bright hot light is conducive for working during the day. This light is bright and hot (meaning it is more towards the white or blue regions of the color temperature scale and it is illuminated at a high level). This may also correspond to a condition wherein the motorized window coverings 52 are fully or mostly opened to let as much light in as possible. A user desiring to set the lights 124 and motorized window coverings 52 to this “Work Day” scene may say “Hello QMotion”, the trigger phrase 80, followed by “Scene” and “Work Day” within the predetermined time period. In response, voice module 12 transmits a command signal 99 to all motorized window coverings 52 wirelessly connected to voice module 12 and directs them to move to the predetermined open position while simultaneously transmitting a command signal 99 to all lights 124 and directs them to illuminate to a high predetermined level of brightness at a relatively hot color on the color temperature scale, or a color more towards white or blue. While the command for this scene setting, is “Work Day” any other term can be used.

As another example, cooler light is conducive for relaxing at home after the work day. This light is cooler (meaning it is more towards the yellow or red regions of the color temperature scale). This light is neither illuminated at a high level, nor a low level. Instead it is illuminated to a medium or comfortable level. This may also correspond to a condition wherein the motorized window coverings 52 are half way opened to let some light in. A user desiring to set the lights 124 and motorized window coverings 52 to this “After Work” scene may say “Hello QMotion”, the trigger phrase 80, followed by “Scene” and “After Work” within the predetermined time period. In response, voice module 12 transmits a command signal 99 to all motorized window coverings 52 wirelessly connected to voice module 12 and directs them to move to the predetermined position while simultaneously transmitting, a command signal 99 to all lights 124 and directs them to illuminate to a predetermined level of brightness at a relatively warm color on the color temperature scale, or a color more towards red or yellow. While the command for this scene setting is “After Work” any other term can be used.

As yet another example, cooler and dim light is conducive for setting a romantic scene at home. This light is cooler (meaning it is more towards the yellow or red regions of the color temperature scale). This light is illuminated at low level. This may also correspond to a condition wherein the motorized window coverings 52 are mostly closed. A user desiring to set the lights 124 and motorized window coverings 52 to this “Romantic” scene may say “Hello QMotion”, the trigger phrase 80, followed by “Scene” and “Romantic” within the predetermined time period. In response, voice module 12 transmits a command signal 99 to all motorized window coverings 52 wirelessly connected to voice module 12 and directs them to move to the predetermined position while simultaneously transmitting a command signal 99 to all lights 124 and directs them to illuminate to a predetermined level of dimness at a relatively warm color on the color temperature scale, or a color more towards red or yellow. While the command for this scene setting is “Romantic” any other term can he used.

In this way the user can use the voice module 12 to set any scene for any purpose. Scenes can include setting all motorized window coverings 52 to the same setting, such as 50% open, or alternatively setting. Various motorized window coverings to various and differing settings; this includes setting the interior shade material 56A and exterior shade material 56B to various settings. Scenes can include setting all lights 124 to the same setting, such as 50% illumination at a predetermined yellow/red color, or alternatively setting various lights 124 to various and differing settings, such as for example, lights in the kitchen to a bright hot light while the lights in the family room near the TV arc set to a cooler dimmer light.

The voice module 12 can also be used to “jog” the lights 124 to a warmer lighting condition more toward the blue range of the color temperature scale) or alternatively to a cooler lighting condition (more toward the red/yellow range of the color temperature scale). This can be accomplished by saying. “Hello QMotion”, the trigger phrase 80, followed by “Warmer” or “Cooler” within the predetermined time period. Each time the user issues this command, the lights move a predetermined amount or to a next predetermined position on the color temperature scale. Further, to accomplish setting the lights 124 to various color temperatures as well as various levels of brightness, the color temperature scale is broken down into a number of predetermined positions or coordinates on the color temperature scale, each of which have a unique command signal associated therewith.

From the above discussion it will be appreciated that a system and method for wireless voice activation of motorized window coverings is presented that improves upon the state of the art.

That is, the system and method for wireless voice activation of motorized window coverings presented is easy to use, intuitive, and simple and provides a plurality of novel ways to activate the motorized window coverings. In addition, the system and method for wireless voice activation of motorized window coverings presented is inexpensive, allows for the activation of a plurality of window coverings and lights simultaneously, allows for grouping of a plurality of motorized window coverings and lights and provides visual as well as audible feedback to the user during the voice recognition process. As such, all of the stated objectives have been accomplished.

While various words or phrases are used herein as voice commands 82, these words or phrases are simply used as examples. These words or phrases can be changed while accomplishing the same functionality. This is especially true when using this system 10 in different languages.

It will be appreciated by those skilled in the art that other various modifications could be made to the device without parting from the spirit and scope of this invention. All such modifications and changes fall within the scope of the claims and are intended to be covered thereby.

What is claimed:

1. A system for voice activation of lights and motorized window coverings, comprising:
a first wirelessly controlled motorized window covering having first shade material;
a first wirelessly controlled light;
a voice activation module;
wherein the voice activation module is wirelessly connected to the first wirelessly controlled motorized window covering and the first wirelessly controlled light;
wherein when a user issues a first voice command which is received by the voice activation module, the voice activation module transmits a first control signal;
wherein when the first wirelessly controlled motorized, window covering receives the first control signal the first wirelessly controlled motorized window covering opens the first shade material; and
wherein when the first wirelessly controlled light receives the first control signal the first wirelessly controlled light turns on.

2. The system of claim 1 wherein the first voice command is “Good Morning”.

3. The system of claim 1 wherein the first wirelessly controlled light gradually brightens over a predetermined amount of time.

4. The system of claim 1 wherein the first wirelessly controlled motorized window covering opens over a predetermined amount of time.

5. The system of claim 1 wherein the voice activation module has a first transceiver and a second transceiver; wherein the first transceiver communicates on a first frequency with the first wirelessly controlled motorized, window covering and the second transceiver communicates on a second frequency with the first wirelessly controlled light.

6. The system of claim 1 wherein the first shade material is blackout material or mostly blackout material.

7. The system of claim 1 wherein the first wirelessly controlled motorized window covering has second shade material.

8. The system of claim 7 wherein the second shade material is a sheer material.

9. A system for voice activation of at lights and motorized window covering, comprising:
a first wirelessly controlled motorized window covering having first shade material;
a first wirelessly controlled light;
a voice activation module;
wherein the voice activation module is wirelessly connected to the first wirelessly controlled motorized window covering and the first wirelessly controlled light;
wherein when a user issues a first voice command which is received by the voice activation module, the voice activation module transmits a first control signal;
wherein when the first wirelessly controlled motorized window covering receives the first control signal the first wirelessly controlled motorized window covering closes the first shade material; and
wherein when the first wirelessly controlled light receives the first control signal the first wirelessly controlled light turns off.

10. The system of claim 9 wherein the first voice command is “Good Night.”

11. The system of claim 9 wherein the first wirelessly controlled light gradually dims over a predetermined amount of time before being turned off.

12. The system of claim 9 wherein the first wirelessly controlled motorized window covering closes over a predetermined amount of time.

13. The system of claim 9 wherein the voice activation module has a first transceiver and a second transceiver; wherein the first transceiver communicates on a first frequency with the first wirelessly controlled motorized window covering and the second transceiver communicates on a second frequency with the first wirelessly controlled light.

14. The system of claim 9 wherein the first shade material is blackout material or mostly blackout material.

15. The system of claim 9 wherein the first wirelessly controlled motorized window covering has second shade material.

16. The system of claim 15 wherein the second shade material is a sheer material.

17. A system for voice activation of a motorized window covering, comprising:
a first wirelessly controlled motorized window covering having first shade material and second shade material;
wherein the first shade material is blackout material or mostly blackout material;
wherein the second shade material is sheer material;
a voice activation module;
wherein the voice activation module is wirelessly connected to the first wirelessly controlled motorized window covering;
wherein the voice activation module receives voice commands from a user, the voice activation module transmits control signals to the first wirelessly controllable motorized window covering; and
wherein the first shade material and the second shade material are motorizably positionable between an open position and a closed position through the voice activation module.

18. A system for voice activation of at lights and motorized window covering, comprising:
a first wirelessly controlled motorized window covering having first shade material;
a first wirelessly controlled light;
a voice activation module;
wherein the voice activation module is wirelessly connected to the first wirelessly controlled motorized window covering and the first wirelessly controlled light;
wherein the voice activation module is programed to receive a plurality of scene commands; and
wherein when a user issues a scene command the voice activation module transmits a control signal to the first wirelessly controlled light causing, it to move to a predetermined color and illumination level, approximately simultaneously the voice activation module transmits a control signal to the first wirelessly controlled motorized window covering causing it to move to a predetermined setting.

19. The system of claim 18 wherein a plurality of wirelessly controlled motorized window coverings are wirelessly connected to the voice activation module.

20. The system of claim 18 wherein a plurality of wirelessly controlled lights are wirelessly connected to the voice activation module.
